(19) United States
(12) Patent Application Publication
(10) Pub. No.: US 2014/0344801 A1
(43) Pub. Date: Nov. 20, 2014

(54) INTEGRATING A WEB APPLICATION INTO AN OPERATING SYSTEM

(71) Applicant: John Nicholas JITKOFF, Palo Alto, CA (US)

(72) Inventor: John Nicholas JITKOFF, Palo Alto, CA (US)

(73) Assignee: GOOGLE INC., Mountain View, CA (US)

(21) Appl. No.: 13/487,034

(22) Filed: Jun. 1, 2012

(51) Int. Cl. G06F 9/445

(52) U.S. Cl. 717/176

(57) ABSTRACT

The subject matter of this specification can be implemented in, among other things, a computer-implemented method for integrating web applications from a web browser into an operating system. The method includes monitoring web application installation in a web browser at a computing device. The method further includes determining that at least one web application has been installed in the web browser. The method further includes creating a link to the web application in an operating system at the computing device in response to determining that the web application has been installed. Activating the link opens the web application in the web browser from a source external to the web browser.

### TECHNICAL FIELD

This instant specification relates to accessing web applications.

### BACKGROUND

A web application is an application that may, in some cases, be accessed over a computer network. Some web applications may be used an offline mode that does not require access over a network or may include both offline and online components. Generally, web applications are presented within a web browser. For example, the web application may include browser-supported markup and script, such as HyperText Markup Language (HTML) and JavaScript. The web browser processes the markup and script of the web application and presents the results to a user using one or more output devices, such as a display device or a speaker. The markup and script also include instructions that allow the user to interact with the web application. Some examples of web applications include a web-based email application, an online retail sales website, an online auction website, and wiki-based websites.

### SUMMARY

In one aspect, a computer-implemented method for integrating web applications from a web browser into an operating system includes monitoring web application installation in a web browser at a computing device. The method further includes determining that at least one web application has been installed in the web browser. The method further includes creating a link to the web application in an operating system at the computing device in response to determining that the web application has been installed. Activating the link opens the web application in the web browser from a source external to the web browser.

Implementations can include any, all, or none of the following features. The method can include determining that the web application has been uninstalled from the web browser and removing the link to the web application from the operating system at the computing device in response to determining that the web application has been uninstalled. Creating the link can include creating the link in a menu of the operating system. Creating the link can include creating the link in a file folder of the operating system. Activating the link can include performing a search in a search application. Monitoring web application installation can include one or more of polling for installation of the web application and receiving an event or notification regarding installation of the web application.

In one aspect, a computer-readable medium storing instructions that when executed cause a computer to perform operations for integrating web applications from a web browser into an operating system, where the operations include monitoring web application installation in a web browser at a computing device. The operations further include determining that at least one web application has been installed in the web browser. The operations further include creating a link to the web application in an operating system at the computing device in response to determining that the web application has been installed. Activating the link opens the web application in the web browser from a source external to the web browser.

Implementations can include any, all, or none of the following features. The operations can further include determining that the web application has been uninstalled from the web browser and removing the link to the web application from the operating system at the computing device in response to determining that the web application has been uninstalled. Creating the link can include creating the link in a menu of the operating system. Creating the link can include creating the link in a file folder of the operating system. Activating the link can include performing a search in a search application. Monitoring web application installation can include one or more of polling for installation of the web application and receiving an event or notification regarding installation of the web application.

In one aspect, a computer-implemented system for integrating web applications from a web browser into an operating system includes a web browser in operation at a computing device that installs at least one web application. The system further includes a sync module that monitors web application installation by the web browser, determines that the web application has been installed and, in response, creates a link to the web application in an operating system at the computing device. Activating the link opens the web application in the web browser from a source external to the web browser.

Implementations can include any, all, or none of the following features. The web browser can uninstall the web application. The sync module can determine that the web application has been uninstalled and, in response, removes the link to the web application from the operating system at the computing device. The sync module can create the link in a menu of the operating system. The sync module can create the link in a file folder of the operating system. The system can include a search application that performs a search for the link and activates the link in response to the search. The sync module can monitor web application installation by one or more of polling for installation of the web application and receiving an event or notification regarding installation of the web application.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for integrating web applications into an operating system.

FIGS. 2A and 2B are examples of graphical user interfaces that show integration of web applications into an operating system.

FIG. 3 is flow chart that shows an example of a process for integrating web applications into an operating system.

FIG. 4 is a schematic diagram that shows an example of a computing device and a mobile computing device.

### DETAILED DESCRIPTION

This document describes systems and techniques for integrating web applications into an operating system. For example, links may be placed in a menu or file system of the operating system that provide access to the web applications. A user may make an input that selects one of the links and opens a corresponding one of the web applications within a web browser. The web applications may be installed by the web browser. The installation and/or removal of web applications is monitored so that the links in the operating system may be synchronized with the web applications that are currently installed.

In some implementations, the menu and/or file system is indexed by a search application. The search application may receive a search input from the user that includes terms associated with a web application, such as terms from a name of the web application. The search application performs a search of the index using the search input to identify a link to the web application. The user may then select the identified link to open the web application within the web browser.

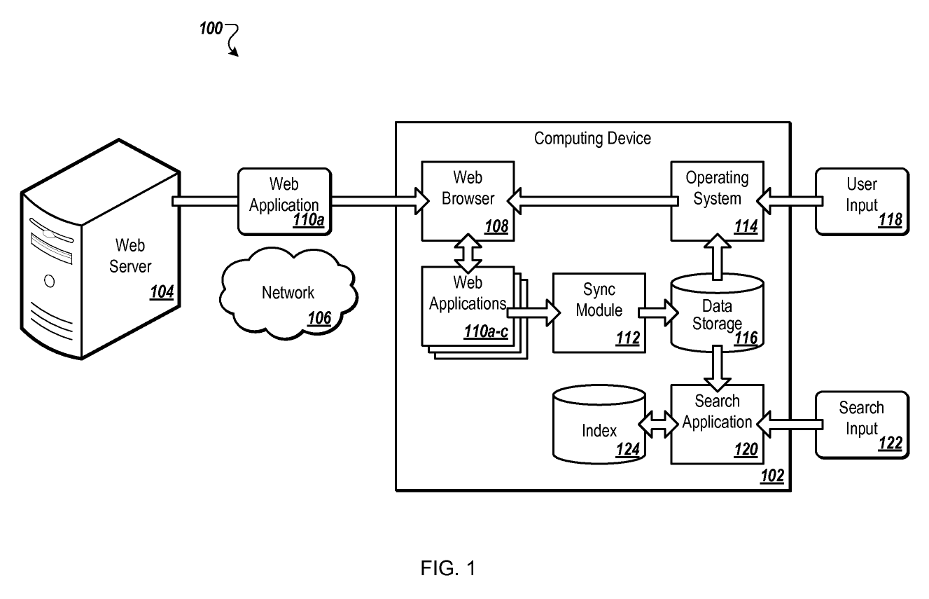

FIG. 1 is a schematic diagram that shows an example of a system 100 for integrating web applications into an operating system. The system 100 includes a computing device 102 in communication with a web server 104 over a network 106. The network 106 can include one or more computing devices, such as the computing devices that make up the Internet. The computing device 102 includes a web browser 108. The web browser 108 is an application in operation at the computing device 102 that presents web content, such as web pages, video, and one or more web applications 110a-c. The web browser 108 can receive web applications, such as the web application 110a, from the web server 104.

The web browser 108 presents a visual output the web application 110a on a display device of the computing device 102. The web browser 108 may also present a audio output of the web application 110a on a speaker device of the computing device 102. The web application 110a may include web-based content, such as one or more of HyperText Markup Language (HTML), client-side scripting language (e.g., JavaScript), Cascading Style Sheets (CSS), Extensible Markup Language (XML), image data, audio data, and video data. The web browser 108 processes the web-based content and presents the output to the user on the display device and/or the speaker device of the computing device 102.

The computing device 102 also includes a sync module 112. The sync module 112 may be a stand alone application separate from the web browser 108. Alternatively, the sync module 112 may be included in the web browser 108. For example, the sync module 112 may be a plug-in or extension to the web browser 108, or an internal component of the web browser 108. In some implementations, the sync module 112 may perform its operations independently of the web browser 108 (e.g., as a stand alone application), such as when the web browser 108 is not in operation.

The sync module 112 monitors the web applications 110a-c that are installed by the web browser 108. The sync module 112 determines that the web browser 108 has installed the web application 110a from the web server 104. The sync module 112 may monitor the installation of the web applications 110a-c by polling for the installation of the web applications 110a-c. For example, the sync module 112 may monitor a particular location within a file system of an operating system 114 at the computing device 102 for the appearance of the web application 110a. In another example, the sync module 112 may monitor information within a database or file for the addition of data for the web application 110a. In another example, the sync module 112 may monitor bookmarks used by the web browser 108 for the addition of a link to the web application 110a.

The sync module 112 may monitor the installation of the web applications 110a-c by receiving an event or notification regarding the installation of the web applications 110a-c. For example, the web browser 108 and/or the operating system 114 may send an event or notification to the sync module 112 after installation of the web application 110a. The sync module 112 monitors the events or notifications sent by the web browser 108 and/or the operating system 114 for an indication that the web application 110a was installed.

In response to determining that the web application 110a was installed in the web browser 108, the sync module 112 creates a link to the web application 110a in the operating system 114 at the computing device 102. The sync module 112 places the link in a data storage 116 that is accessible by the operating system 114. For example, the sync module 112 may place the link in a menu of the operating system 114. The menu may be represented by data in the data storage 116. In another example, the sync module 112 may create the link in a file folder of the operating system 114. The file folder may be represented by a file system in the data storage 116. In some implementations, the link in the file folder may be used by the operating system 114 for the menu.

The operating system 114 allows a user to make a user input 118 that activates the link. The operating system 114 may receive the user input 118 using either the file folder or the menu. In response to receiving the user input 118, the operating system 114 provides the link to the web browser 108. The sync module 112 places an address of the web application 110a in the link, such as a uniform resource identifier (URI) and/or a uniform resource locator (URL) of the web application 110a. The address instructs the web browser 108 to open the web application 110a.

The sync module 112 may also include other parameters in the link. For example, the parameters may direct the web browser 108 to open the web application 110a in an application mode. The application mode is a mode of operation of the web browser 108 in which one or more controls are not displayed within the web browser 108 user interface. The application mode may be designed to make the web application 110a appear more like a traditional desktop application to the user. For example, the application mode may not display a toolbar with navigation controls (e.g., forward, back, and/or refresh) and/or a tab bar with titles of separate interface tabs where the user typically does not navigate away from the web application 110a or where the web application 110a provides its own navigation controls within its own user interface.

In some implementations, the computing device 102 includes a search application 120. The search application 120 allows a user to make a search input 122 that includes information that identifies an application at the computing device 102 that the user intends to open. The search application 120 uses the information in the search input 122 to search an index 124. The index 124 includes data that describes the applications that are installed at the computing device 102. The data describing the applications is gathered from the data storage 116, such as from file folders, menus, databases, and other data that describes the applications that are installed at the computing device 102. If the search of the index 124 results in a most likely candidate, then the search application 120 activates the application associated with the result, such as the link to the web application 110a. Alternatively, if there are multiple possible results, the search application 120 may present a corresponding list of possible applications (e.g., including the link to the web application 110a) to the user and the user may select the link to the web application 110a to activate the web application 110a in the web browser 108.

While monitoring installation of the web applications 110a-c, the sync module 112 may also determine that the web application 110a has been uninstalled from the web browser 108. The sync module 112 may monitor the installation of the web applications 110a-c by polling for the installation of the web applications 110a-c. For example, the sync module 112 may periodically monitor the data storage 116 for removal of the web application 110a. In another example, the sync module 112 may monitor information within a database or file for the removal of data for the web application 110a. In another example, the sync module 112 may monitor bookmarks used by the web browser 108 for the removal of a link to the web application 110a.

The sync module 112 may monitor the installation of the web applications 110a-c by receiving an event or notification regarding installation of the web applications 110a-c. For example, the sync module 112 may receive an event or notification from the web browser 108 and/or the operating system 114 that the web application 110a has been uninstalled. The sync module 112 monitors the events or notifications from the web browser 108 and/or the operating system 114 to determine that the web application 110a has been uninstalled.

In response to determining that the web application 110a has been uninstalled, the sync module 112 removes the link to the web application 110a from the operating system 114 at the computing device 102. For example, the sync module 112 may remove the link from the file folder and/or the menu of the operating system 114.

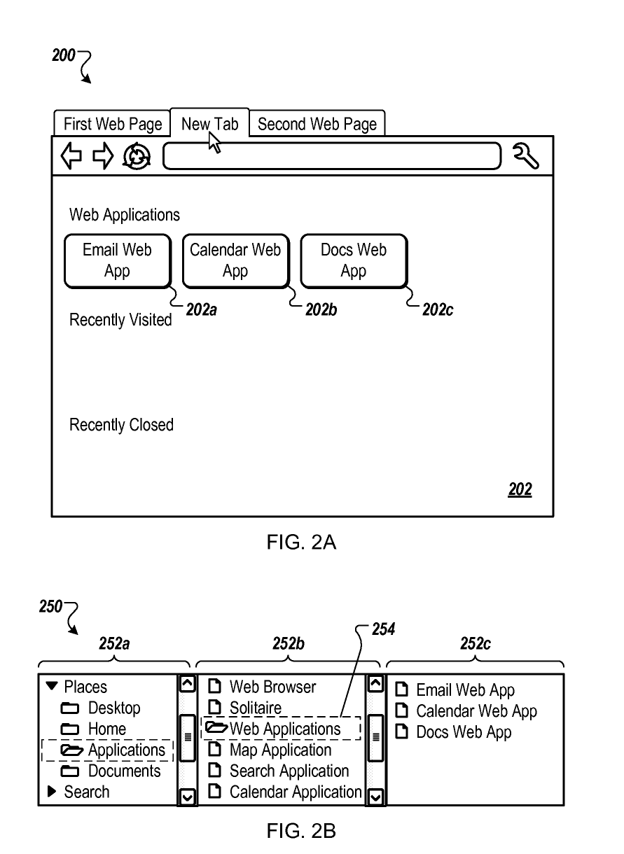

FIG. 2A is an example of a graphical user interface 200 for a web browser in operation at a computing device. The graphical user interface 200 includes a presentation area 202 that presents web content, such as web content for a new tab web page. The new tab web page includes one or more controls 204a-c for each of one or more web applications that are currently installed in the web browser. For example, the controls 204a-c may correspond to the web applications 110a-c of FIG. 1, respectively. A user can select the control 204a, for example, to send a request to the web browser 108 to open or activate the web application 110a. The web browser 108 opens the web application 110a and presents a web interface for the web application 110a within the presentation area 202 of the graphical user interface 200. Alternatively, the web browser 108 may open or activate the web interface for the web application 110a in another presentation area of another tab or instance of the graphical user interface for the web browser 108.

A sync module, such as the sync module 112, monitors the installation of the web applications 110a-c within the web browser 108. The sync module synchronizes corresponding links in an operating system of the computing device. For example, the sync module may determine that the web application 110a has been added to the web browser 108. Accordingly, the sync module adds a link to the web application 110a in the operating system. In another example, the sync module may determine that the web application 110a has been removed from the web browser 108. Accordingly, the sync module removes the link to the web application 110a from the operating system.

FIG. 2B is an example of a graphical user interface 250 for an operating system that shows integration of web applications into the operating system, such as the operating system 114 of FIG. 1. The graphical user interface 250 may be, for example, a file manager of the operating system that shows files and folders within a data storage that is accessible by the operating system, such as the data storage 116. In another example, the graphical user interface 250 may be a menu of the operating system that shows files and applications that are accessible by the operating system. Information describing the files and applications in the menu may be stored in a data storage, such as the data storage 116.

The graphical user interface 250 includes one or more sections 252a-c. The section 252b includes a list of applications and groups of applications. The sync module may, for example, generate data for a folder 254 in the graphical user interface 250. The data for the folder 254 may be stored, for example, in the data storage 116. A user can then select the folder 254 to see a list of the web applications 110a-c in the section 252c. As web applications are added and/or removed from the web browser, the sync module accordingly adds and/or removes data for the web applications in the section 252c of the graphical user interface 250.

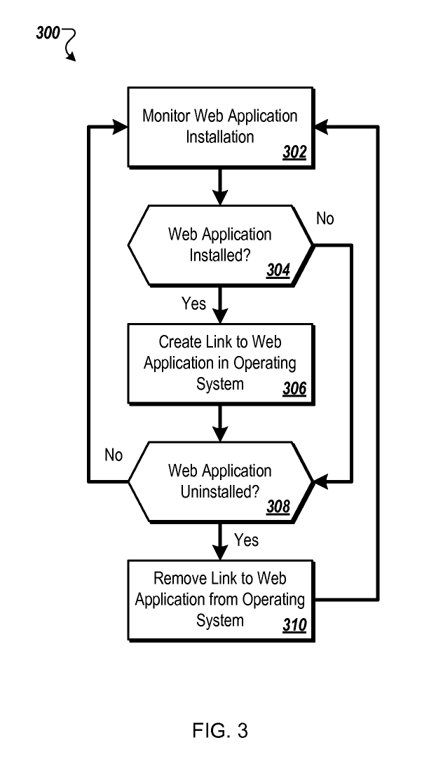

FIG. 3 is flow chart that shows an example of a process 300 for integrating web applications into an operating system. The process 300 may be performed, for example, by a system such as the system 100 and the graphical user interface 200. For clarity of presentation, the description that follows uses the system 100 and the graphical user interface 200 as examples for describing the process 300. However, another system, or combination of systems, may be used to perform the process 300.

The process 300 begins, in step 302, with monitoring web application installation in a web browser at a computing device. For example, the sync module 112 may check for new web applications in the data storage 116 and/or receive a notification from the web browser 108 and/or the operating system 114 that a web application has been installed.

In step 304, if it is determined that at least one web application has been installed in the web browser, then, in step 306, a link to the web application is created in an operating system at the computing device in response to determining that the web application has been installed. Activating the link opens the web application in the web browser from a source external to the web browser. Creating the link may include creating the link in a menu of the operating system. Creating the link may include creating the link in a file folder of the operating system. For example, the sync module 112 may generate data for the web application 110a in the section 252c of the graphical user interface 250 for the file manager and/or the menu of the operating system 114.

Activating the link may include performing a search in a search application. For example, the search application 120 may use an input from a user to search through the index 124, which includes the file manager and/or the menu data for the web applications 110a-c. The search application 120 provides a search result to the user that includes the web application 110a and the user may select the search result to initiate the web application 110a in the web browser 108.

In step 308, if it is determined that the web application has been uninstalled from the web browser, then, in step 310, the link to the web application is removed from the operating system at the computing device in response to determining that the web application has been uninstalled. For example, the sync module 112 may check for removal of the web application 110a from the data storage 116 and/or receive a notification from the web browser 108 and/or the operating system 114 that the web application 110a has been uninstalled. Accordingly, the sync module 112 may remove the data for the web application 110a from the file manager and/or the menu of the operating system 114.

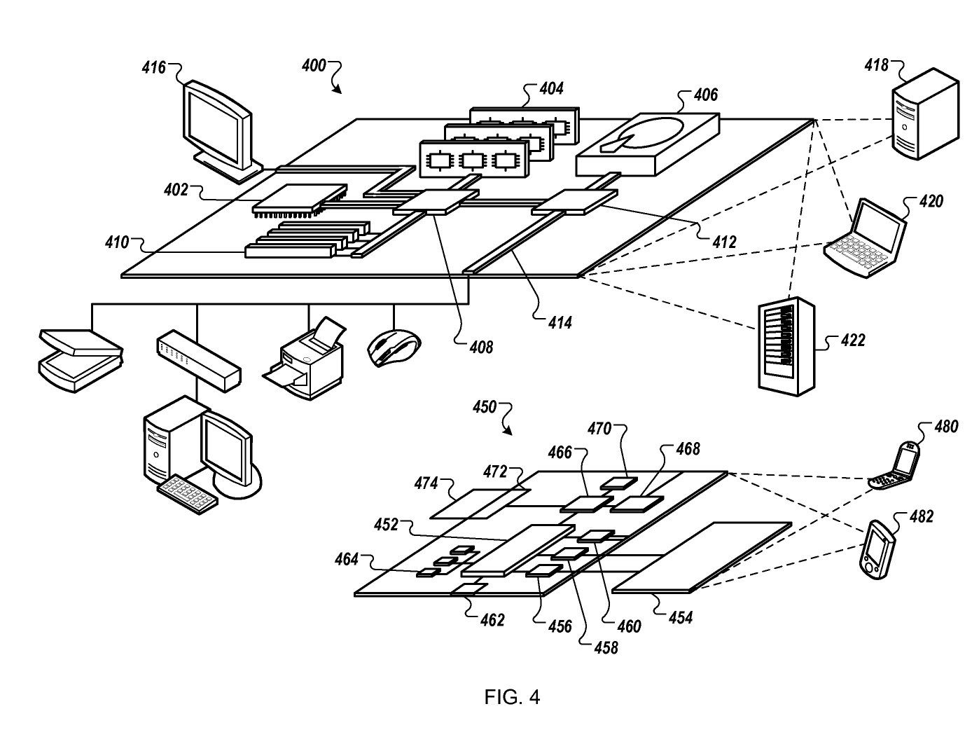

FIG. 4 is a schematic diagram that shows an example of a computing device 400 and an example of a mobile computing device 450 that may be used to implement the systems and methods described in this document, as either a client or as a server or plurality of servers. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smartphones, and other similar computing devices. Additionally the computing device 400 or the mobile computing device 450 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations.

A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is exemplary only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 418, or multiple times in a group of such servers. In addition, it may be implemented in a personal computer such as a laptop computer 420. It may also be implemented as part of a rack server system 422. Alternatively, components from the computing device 400 may be combined with other components in a mobile device (not shown), such as the mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. Additionally, the processor 452 may be implemented using any of a number of architectures. For example, the processor 452 may be a CISC (Complex Instruction Set Computers) processor, a RISC (Reduced Instruction Set Computer) processor, or a MISC (Minimal Instruction Set Computer) processor. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. The memory 464 may include, for example, flash memory and/or NVRAM memory (non-volatile random access memory).

An expansion memory 474 may also be provided and connected to the mobile computing device 450 through an expansion interface 472, which may include, for example, a SIMM (Single In-Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a secure manner.

In some implementations, a computer program product is tangibly embodied in an information carrier. The computer program product contains instructions that, when executed, perform one or more methods, such as those described above. The information carrier is a computer- or machine-readable medium, such as the memory 464, the expansion memory 474, or memory on the processor 452. In some implementations, the computer program product may be received, for example, over the transceiver 468 or the external interface 462 and stored in the computer- or machine-readable medium.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method for integrating web applications from a web browser into an operating system, the method comprising:
monitoring web application installation in a web browser at a computing device;
determining that at least one web application has been installed in the web browser; and
creating a link to the web application in an operating system at the computing device in response to determining that the web application has been installed, wherein activating the link opens the web application in the web browser from a source external to the web browser.

2. The method of claim 1, further comprising:
determining that the web application has been uninstalled from the web browser; and
removing the link to the web application from the operating system at the computing device in response to determining that the web application has been uninstalled.

3. The method of claim 1, wherein creating the link comprises creating the link in a menu of the operating system.

4. The method of claim 1, wherein creating the link comprises creating the link in a file folder of the operating system.

5. The method of claim 1, wherein activating the link comprises performing a search in a search application.

6. The method of claim 1, wherein monitoring web application installation comprises one or more of polling for installation of the web application and receiving an event or notification regarding installation of the web application.

7. A computer-readable medium storing instructions that when executed cause a computer to perform operations for integrating web applications from a web browser into an operating system, the operations comprising:
monitoring web application installation in a web browser at a computing device;
determining that at least one web application has been installed in the web browser; and
creating a link to the web application in an operating system at the computing device in response to determining that the web application has been installed, wherein activating the link opens the web application in the web browser from a source external to the web browser.

8. The computer-readable medium of claim 7, wherein the operations further comprising:
determining that the web application has been uninstalled from the web browser; and
removing the link to the web application from the operating system at the computing device in response to determining that the web application has been uninstalled.

9. The computer-readable medium of claim 7, wherein creating the link comprises creating the link in a menu of the operating system.

10. The computer-readable medium of claim 7, wherein creating the link comprises creating the link in a file folder of the operating system.

11. The computer-readable medium of claim 7, wherein activating the link comprises performing a search in a search application.

12. The computer-readable medium of claim 7, wherein monitoring web application installation comprises one or more of polling for installation of the web application and receiving an event or notification regarding installation of the web application.

13. A computer-implemented system for integrating web applications from a web browser into an operating system, the system comprising:
a web browser in operation at a computing device that installs at least one web application;
a sync module that monitors web application installation by the web browser, determines that the web application has been installed and, in response, creates a link to the web application in an operating system at the computing device, wherein activating the link opens the web application in the web browser from a source external to the web browser.

14. The system of claim 13, wherein the web browser uninstalls the web application, and wherein the sync module determines that the web application has been uninstalled and, in response, removes the link to the web application from the operating system at the computing device.

15. The system of claim 13, wherein the sync module creates the link in a menu of the operating system.

16. The system of claim 13, wherein the sync module creates the link in a file folder of the operating system.

17. The system of claim 13, further comprising a search application that performs a search for the link and activates the link in response to the search.

18. The system of claim 13, wherein the sync module monitors web application installation by one or more of polling for installation of the web application and receiving an event or notification regarding installation of the web application.
